(19) United States
(12) Patent Application Publication
(10) Pub. No.: US 2003/0032425 A1
(43) Pub. Date: Feb. 13, 2003

(54) Schema change method of dual system

(76) Inventors: Hong-Sik Kim, Anyang (KR); Jae-Woo Hyoung, Anyang (KR); Nam-Jin Kim, Seoul (KR)

Correspondence Address: FLESHNER & KIM, LLP, P.O. Box 221200, Chantilly, VA, 20153-1200, US

(21) Appl. No.: 10/214,777

(22) Filed: Aug. 9, 2002

(30) Foreign Application Priority Data
Aug. 11, 2001 (KR) 48573/2001
Aug. 11, 2001 (KR) 48574/2001

(51) Int. Cl. H04Q 7/20; H04M 11/00

(52) U.S. Cl. 455/426; 455/403

(57) ABSTRACT

Disclosed is a schema change method of a dual system capable of continuously providing service in dual system circumstances and simultaneously performing a schema change. The method preferably includes applying a changed schema to a standby system, connecting the standby system with an active system by a dual synchronous link, comparing schema versions of the systems, storing the data received from the database of the operating active system in the standby system, storing data received from a change buffer of the active system in the standby system, and performing a fail-over of the standby system and the active system.

### BACKGROUND OF THE INVENTION

1. Field of the Invention

The present invention relates to a schema change method of a dual system, and in particular to a schema change method of a dual system which is capable of providing continuous service in dual system circumstances while simultaneously changing a schema.

2. Background of the Related Art

In order to provide continuous service to a subscriber, a mobile communication system is typically a dual system. When an error or a failure occurs in a main system, an automatic fail-over is performed from the main system into a sub-system. The communication system can accordingly be operated continuously.

The duplex system consists of two physically independent systems. These systems are an active system performing a current service, and a standby system not providing service at present, but providing service in substitute for the active system when an error occurs in the active system. The standby system thus has to maintain the same configuration/shape and data as those of the active system, so as to provide the same service in substitute for the active system when the active system cannot provide the service.

FIG. 1 is a diagram illustrating a structure of a related art dual system. As depicted in FIG. 1, a first system 100 in an active state and a second system 200 in a standby state are shown. The first system 100 and second system 200 each respectively include a database 110, 210 for storing data necessary to system operation, a transaction processing block (TPB) 120, 220 for processing transactions that occur in interlocking with other systems, and a dual synchronization control (DSC) 130,230 for managing an active/standby dual state of each system. The systems also include a change buffer 140, 240 for storing change data of the database when applying a new schema.

In the related art dual system, when a schema of the database 110, 210 is changed, the operation of both the first and the second systems 100, 200 ceases. Then, data that existed in the databases 110, 210 immediately prior to the system stop are converted into data having a newly changed schema structure. The databases 110, 210 converted into the changed schema structure are loaded to a CPU (not shown), and the systems 100, 200 resume operations.

The databases 110, 210 respectively have a structure having one index table per one table. Each table and each index includes a characteristic memory key and a memory identifier. The characteristic memory key is a number or a character distinguishing each table or forming a region used in search of each table's location, and the memory identifier is a value allocated from an operating system as an integer on the basis of a characteristic memory key value. Information such as a table ID, a shared memory key, and a start address are stored in a table and a mapping table of a memory device. The mapping table has a used tag displaying usage of a certain memory key. An additional processor for generating a data file and loading it onto a disk is required to change a schema in the related art system.

The related art schema change method of the dual system has various problems. For example, when a schema of a database is changed, because both active and standby systems have to be stopped to convert data existed in the database into data having the changed schema structure, it is impossible to provide service to subscribers during that time.

In addition, because an additional processor performing a schema change function has to make a database file appropriate to a changed schema and load it onto a disk, a service may not be continuously provided during that time.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a schema change method of a dual system that is capable of providing continuous service in dual system circumstances while simultaneously changing a schema.

In order to achieve the above-mentioned objects in whole or in parts, there is provided a schema change method of a dual system, including applying a changed schema to a standby system; checking a schema version of an active system; converting data received form the operating active system into a changed schema structure and storing it in the standby system; and performing a fail-over of the standby system and the active system.

In order to achieve the above-mentioned objects in whole or in parts, there is further provided a schema change method of a dual system, including applying a changed schema to a standby system; connecting the standby system with an active system by a dual synchronous link; comparing schema versions of the systems; storing data received from a database of the operating active system in the standby system; storing data received from a change buffer of the active system in the standby system; and performing a fail-over of the standby system and the active system.

In order to achieve the above-mentioned objects in whole or in parts, there is further provided a schema change method of a dual system, including applying a changed schema to a standby system; connecting the standby system with an active system by a dual synchronous link; comparing schema versions of the systems; storing data received from the database of the operating active system in the standby system; storing data received from a change buffer of the active system in the standby system; performing a fail-over of the standby system and the active system; and switching the operation state of the standby system and the active system.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a related art dual system;

FIGS. 2a and 2b illustrate schema change information in accordance with a preferred embodiment of the present invention;

FIG. 3 is a flow chart illustrating a schema change method of a dual system in accordance with a preferred embodiment of the present invention;

FIGS. 4a and 4b are flow charts illustrating a first embodiment of a schema change method of a dual system in accordance with a preferred embodiment of the present invention;

FIG. 5 illustrates signal flows for schema change in the dual system in accordance with a preferred embodiment of the present invention;

FIGS. 6a and 6b are flow charts illustrating a data converting method for schema change in the dual system in accordance with a preferred embodiment of the present invention;

FIG. 7 illustrates a data converting method in accordance with a preferred embodiment of the present invention;

FIGS. 8a and 8b are flow charts illustrating a second embodiment of a schema change method of a dual system in accordance with preferred embodiment of the present invention; and

FIG. 9 illustrates signal flows for operation of a new standby system in accordance with a preferred embodiment of the present invention.

### DETAILED DESCRIPTION OF PREFERRED EMBODIMENTS

Hereinafter, embodiments of a schema change method of a dual system in accordance with the present invention will be described with reference to the accompanying drawings.

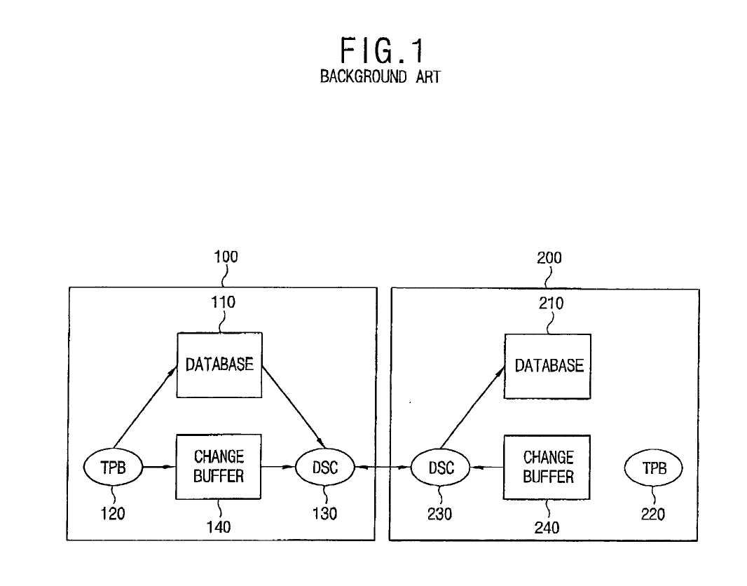

A schema change apparatus of a dual system in accordance with a preferred embodiment of the present invention will be described with reference to accompanying block diagram shown in FIG. 1.

A transaction processing block (TPB) 120 preferably stores data changed by a transaction in interlocking with other systems in databases 110, 210, and stores data changed by a transaction that occurs when data is copied in a second (standby) system 200 from the database 110 of a first (active) system 100 in a change buffer 140.

Dual synchronization controls (DSCs) 130, 230 manage an active/standby dual state. When a changed schema is applied to the second system 200 in a standby state and the second system 200 is operated, the DSC 230 of the second system 200 sets a dual synchronous link with the DSC 130 of the first system 100. The DSC 130 of the first system 100 then gains access to data stored in the database 110 of the first system 100, transmits the data to the DSC 230 of the second system 200, and also gains access to data of the change buffer 140 and transmits the data to the database 210 of the second system 200 through the DSC 230. The DSCs 130, 230 thus cause the first and the second systems 100, 200 to maintain the same database.

The change buffer 140 preferably stores data changed by a transaction that occurs when data is copied in the second system 200 from the first system 100. The databases 110,210 store data required for the system operation.

An operation of the schema change apparatus of the dual system in accordance with the preferred embodiment will next be described.

In order to change a schema of the databases 110, 210, the second system 200 in the standby state (not providing a service at present) is first stopped. Then, a changed database schema is applied to the second system 200. The operation of the second system 200 is next resumed, and the second system sets a dual synchronous link connection with the first (active) system 100. The DSC 230 of the second system 200 compares schema version information of the first system 100 with its schema version information. If the comparison indicates that they are different, the DSC 230 converts data transmitted from the first system 100 into the changed schema structure, and stores it in the database 210. Next, fail-over is performed between the first system 100 transmitting all data stored in the database 110 and the change buffer 140 to the second system 200 and the second system 200 using the new schema. The operation state is converted from each other, and accordingly the system can provide continuous service.

In more detail, the first (active) system 100 is converted into the standby state, and the second (standby) system is converted into the active state. A new package is then applied to the first system 100 in the standby state, and the system resumes operation. The first system 100 thus maintains the same configuration of the second system 200 by receiving data of the database 210 and the change buffet 240 of the second (now active) system 200 and is then operated as the standby system.

As described above, when a database schema change situation occurs (i.e., a new package has to be applied), by transmitting the configuration of the entire database to the system using the new package, dual synchronization of the two systems can be maintained. Herein, the DSCs 130, 230 preferably have schema change information including data relation information and data attribute information.

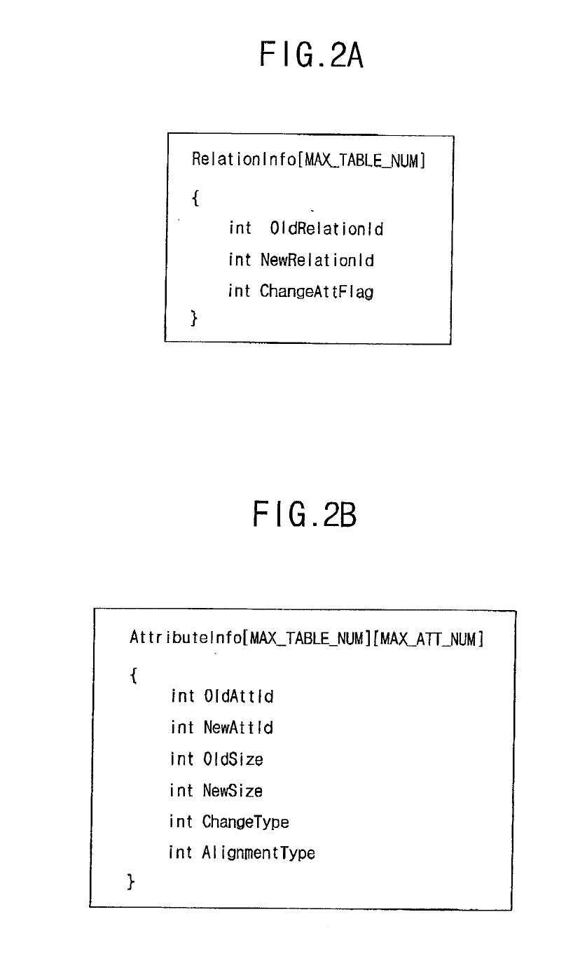

FIGS. 2a and 2b illustrate schema change information of the DSC in accordance with the preferred embodiment.

The relation information (as table information) included in the database schema preferably includes an OldRelationID (old schema table ID), a NewRelationID (new schema table ID), and a ChangeAttFlag displaying a change in attribute of a pertinent table.

In addition, the attribute information has table attribute change information. The attribute information preferably includes an OldAttID (old attribute ID), a NewAttID (new attribute ID), an OldSize (old attribute size), a NewSize (new attribute size), a ChangeType indicating a change type of the attribute, and an AlignmentType indicting an alignment type. Herein, the AlignmentType information is used in arranging an alignment in attribute size change.

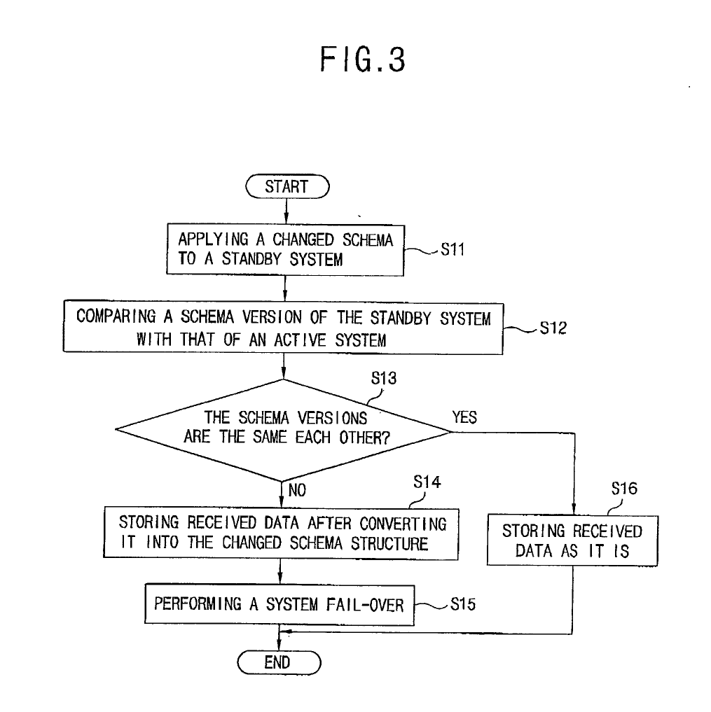

FIG. 3 is a flow chart illustrating a schema change method of a dual system in accordance with a preferred embodiment. As depicted in FIG. 3, a change schema is first applied to the database of the standby system, as shown in S11. Schema version information of the standby system is then compared with that of the active system, as shown in S12. It is next determined whether the information is the same, as shown in S13.

If the schema version information is not the same, data of the active system is converted into a schema structure and stored, as shown in S14. A fail-over between the active system and the standby system is then performed, as shown in S15. However, if the schema version information is the same, data from the active system is stored as it is in the standby system, as shown in S16.

After converting and storing the data, change data of the change buffer, for storing change data generated in receiving the data of the active system, are also converted and stored.

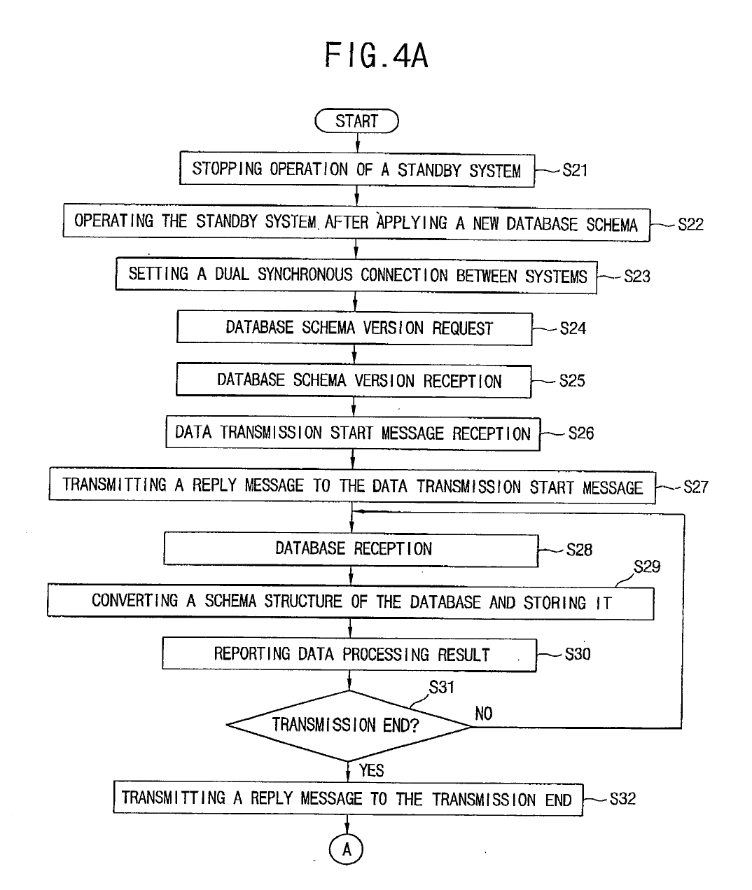

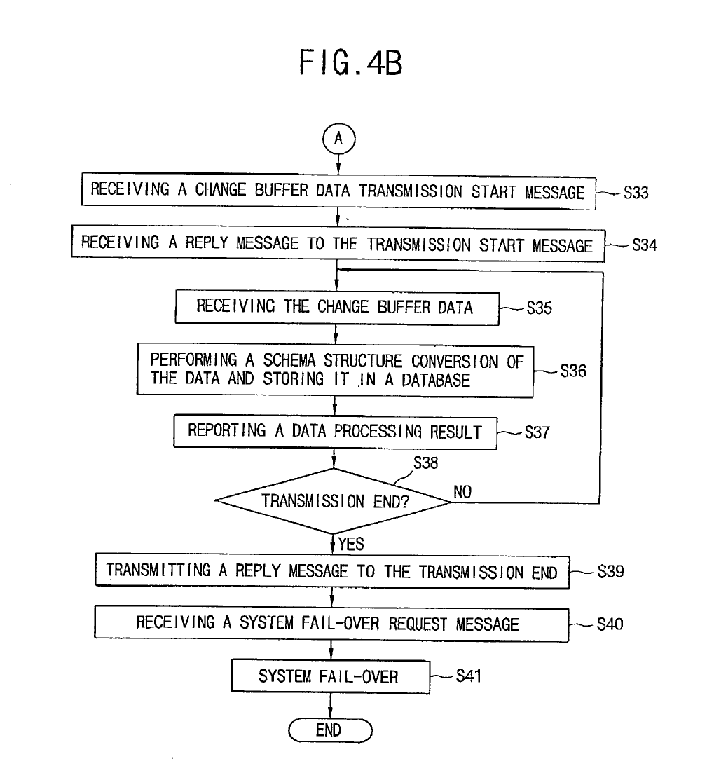

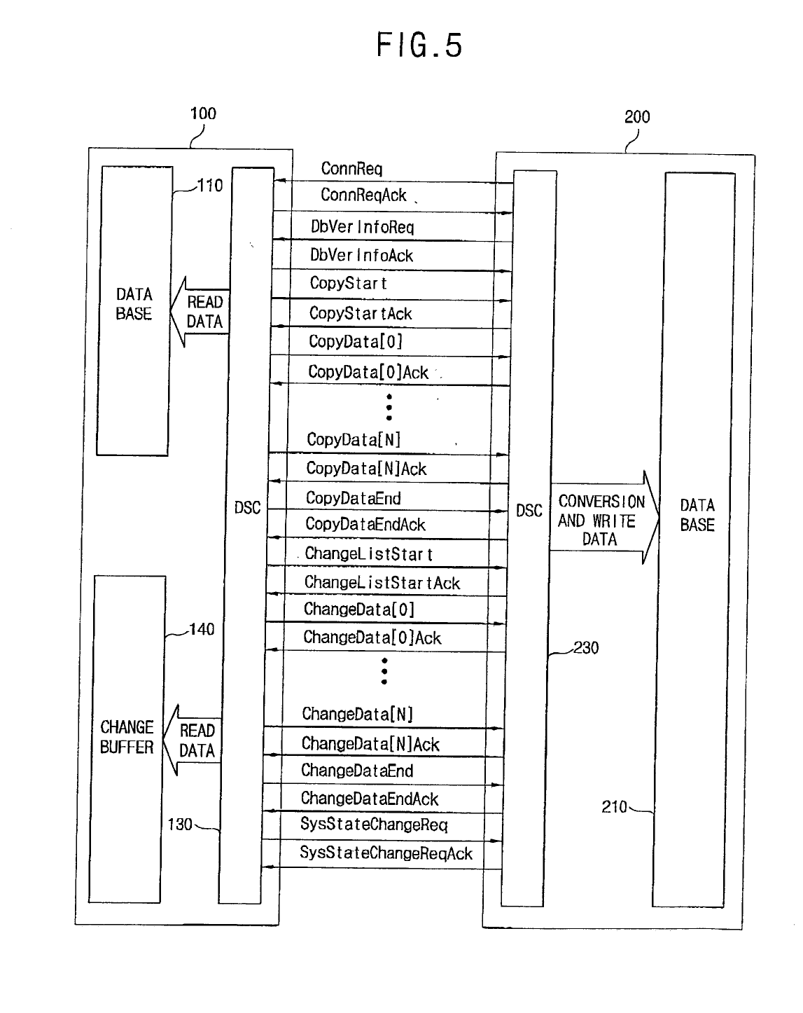

FIGS. 4a, 4b, and 5 illustrate a schema change operation of the database of the dual system in accordance with the preferred embodiment.

In change of a schema of the database, in order to apply a new schema to the dual system, the operation of the second system 200 in the standby state (not providing a service) is first stopped, as shown in S21. Herein, because the first system 100 in the active state continuously provides the service, the second system 200 can be stopped.

The new schema applied to the second system 200 converts data stored in the database 210 into a schema structure. The newly converted database 210 is then loaded to a main memory (not shown), and the operation of the second system 200 is resumed, as shown in S22.

To contact the first system 100 through the dual synchronous link, the DSC 230 of the second system 200 transmits a ConnReq (connection request message) to the DSC 130 of the first system 100. The DSC 130 of the first system 100, upon receiving the ConnReq, transmits a ConnReqAck (reply message to the connection request message) to the DSC 230 of the second system 200. The dual synchronous link is thus set, as shown in S23.

When the dual synchronous link setting is finished, the DSC 230 of the second system 200 transmits its schema version information and a DbVerInfoReq (first system's database schema version information request message) to the DSC 130 of the first system 100 to check whether a schema of the first system 100 is changed, as shown in S24.

Upon receiving the DbVerInfoReq, the DSC 130 of the first system 100 gains access to the version information stored in the database 110, and transmits a DbVerInfoAck (reply message to the schema version information request) to the DSC 230 of the second system 200, as shown in S25. The DSC 130 of the first system also transmits a CopyStart (data-stored in the database 110-transmission message) to the DSC 230 of the second system, as shown in S26.

If the DSC 230 of the second system 200 recognizes the schema version of the first system 100 is different from that of the second system 200 based on the DbVerInfoAck transmitted from the DSC 130 of the first system 100, it transmits a CopyStartAck (reply message to the CopyStart) to the DSC 130 of the first system 100 in order to communicate a data reception standby, as shown in S27.

The DCS 130 of the first system 100 thus recognizes that the second system 200 is ready to receive data through the CopyStartAck, and gains access to a first data stored in the database 110 and transmits it to the second system 200, as shown in S28. The DSC 230 of the second system 200, receiving the first data from the first system 100, converts the data into a change schema structure, and stores it in the database 210, as shown in S29. The DSC 230 of the second system 200 then transmits a CopyData[0]Ack (first data's processing result reply message), as shown in S30.

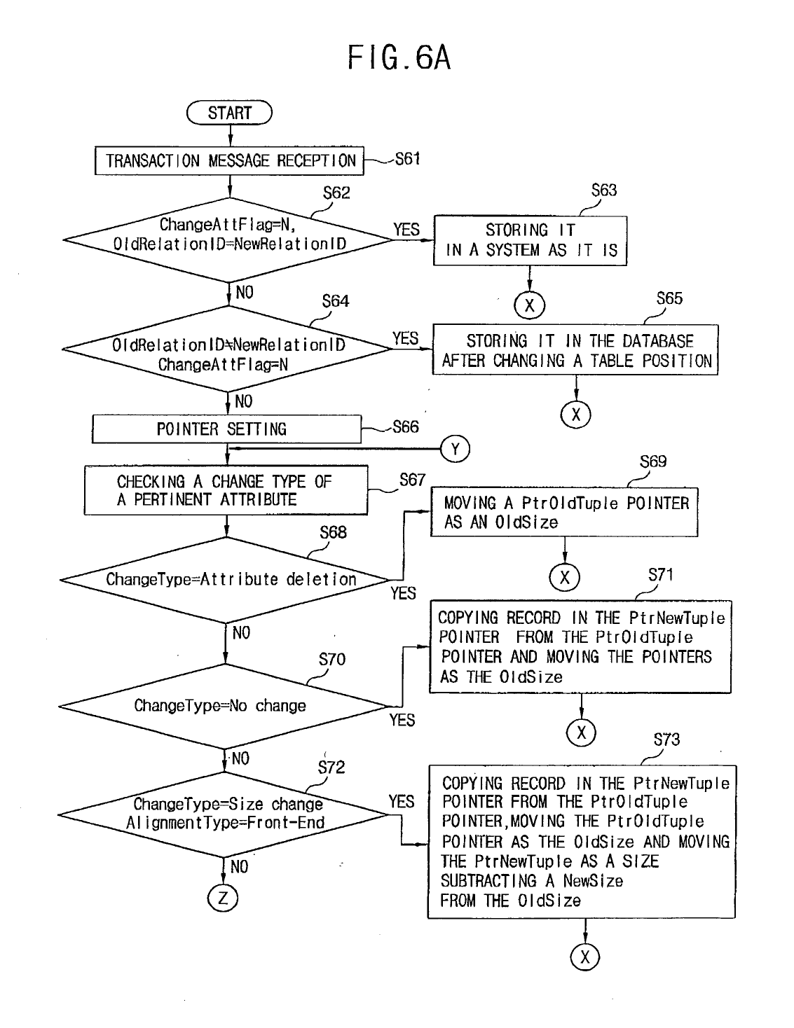

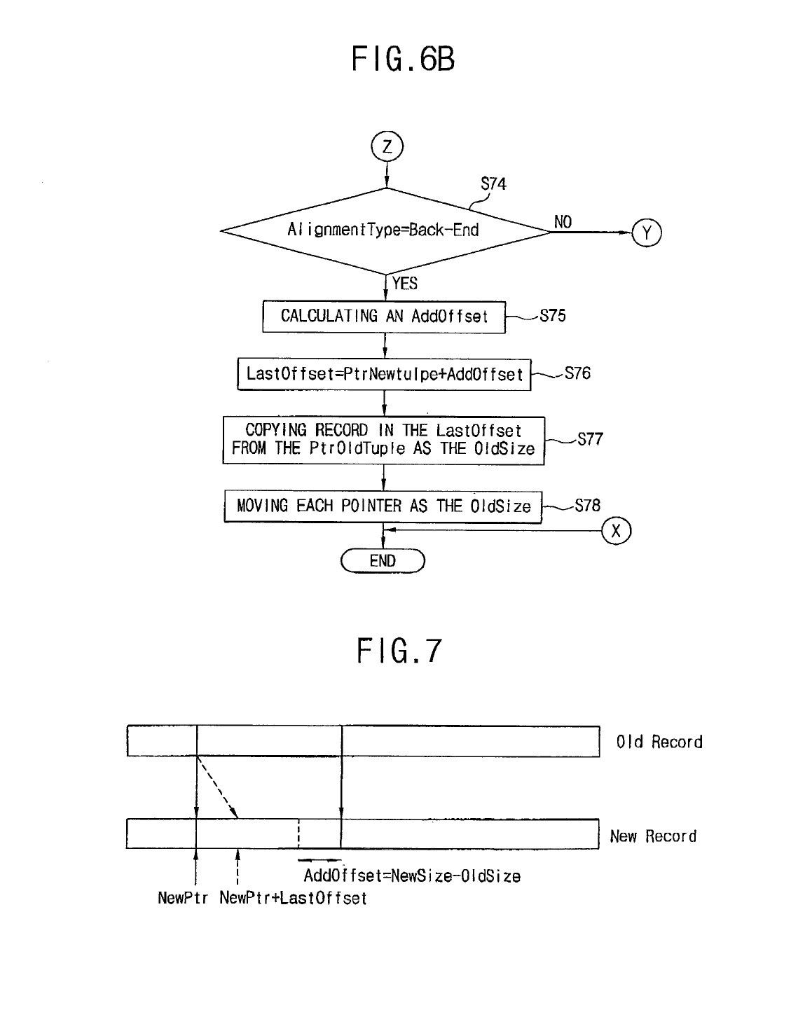

A data conversion method will be described in more detail with reference to FIGS. 6a and 6b.

First, the second system 200, having the new package, receives record and table ID from the DSC 130 of the first system 100, as shown in S61. The second system determines whether the table has been changed by using the received record and table ID. Thus, it is judged whether there is a change in a ChangAttFlag (indicating attribute change in a pertinent table) of the schema information and whether an OldRelationID and a NewRelationID are the same, as shown in S62.

If there is no change in the ChangAttFlag (indicating attribute change in the pertinent table) of the schema information, and if the OldRelationID and the NewRelationID are the same, it is determined that there has been no change in the table. Accordingly, the transmitted record is stored as is in the second system 200, as shown in S63.

It is next determined whether there is no change in the ChangAttFlag (indicating attribute change in the pertinent table) of the schema information and whether the OldRelationID and the NewRelationID are different from each other, as shown in S64. If there is no change in the ChangAttFlag, but the OldRelationID and the NewRelationID are different from each other, it is determined that there is no change in the Attribute of the pertinent table, but that only the table ID has been changed. Accordingly, the transmitted record is stored in the second system 200 after changing only the ID, as shown in S65.

However, if there is a change in the ChangAttFlag of the schema information and the OldRelationID and the NewRelationID are the same, it is determined that a change has occurred in the Attribute of the pertinent table. Accordingly, a pointer indicating a transmitted record is set, as shown in S66.

In more detail, a PtrOldTuple pointer indicating the transmitted record and a PtrNewTuple pointer indicating a new record stored after converting are set. Additionally, a change type of the pertinent attribute is checked from a first attribute to the last attribute of the record by using the pointer, as shown in S67.

After checking, it is determined whether a change type is a quick deletion, as shown in S68. When the pertinent change type is a quick deletion, the PtrOldTuple pointer is moved as the OldSize, as shown in S69. When the pertinent change type has a “no change” value, as shown in S70, after copying the record in the PtrNewTuple pointer position from the PtrOldTuple pointer position as the OldSize, positions of the two pointers are moved as the OldSize, as shown in S71.

When the pertinent change type is “there is a change in the attribute size,” it is determined whether the alignment is a front-end type by checking the alignment shape, as shown in S72. The alignment consists of the front-end type storing the increased attribute from the front, and a back-end type storing the increased attribute from the back.

When the alignment is the front-end type, after copying the record in the PtrNewTuple pointer position from the PtrOldTuple pointer position as the OldSize, a position of the PtrOldTuple pointer is moved as the OldSize. Additionally, a position of the PtrNewTuple pointer is moved as a size subtracting the OldSize from the NewSize of the attribute information, as shown in S73.

When the alignment is the back-end type, as shown in S74, as depicted in FIG. 6, an AddOffset value is calculated by subtracting the OldSize from the NewSize, as shown in S75. A LastOffset value is also calculated by adding the AddOffset value to a present position of the PtrNewTuple pointer, as shown in S76. After copying the record in the LastOffset position from the PtrOldTuple pointer position as the OldSize, as shown in S77, a position of the PtrOldTuple pointer is moved as the OldSize, as shown in S78.

Then, it is determined whether all of the data stored in the database 110 of the first system 100 have been converted through the above-described steps and have been transmitted to the second system 200, as shown in S31. If the result is NO, steps S28˜S30 are repeatedly performed until data transmission is completed.

However, when data of the database 110 of the first system 100 are all transmitted to the second system 200, the DSC 130 of the first system 100 transmits a CopyDataEnd (data transmission end message) to the second system 200. The second system 200, upon receiving the message, transmits a CopyDataEndAck (reply message to the data transmission end) to the DSC 130 of the first system 100, as shown in S32.

The change buffer 140 of the first system 100 stores change data that occurs while data stored in the database 110 of the first system 100 are transmitted to the second system 200 and converted into a new schema format.

Accordingly, the DSC 130 of the first system 100, upon receiving the CopyDataEndAck (reply message to the data transmission end), transmits a ChangeListStart (change data-stored in the change buffer 140-transmission start message) to the DSC 230 of the second system 200, as shown in S33. The DSC 230 of the second system 200, upon receiving the ChangeListStart, transmits a ChangeListStartAck (reply message to the change data transmission start) to the first system 100, as shown in S34.

The DSC 130 of the first system 100 then determines whether the second system 200 is ready to receive the change data through the received ChangeListStartAck (reply message to the change data transmission start), and gains access to a first data stored in the change buffer 140. The DSC 130 of the first system then transmits the first data to the second system 200, as shown in S35. The DSC 230 of the second system 200, upon receiving the change data from the first system 100, converts the data into a new schema format, and stores the converted data in the database 210, as shown in S36. The DSC 230 of the second system then transmits a ChangeData[0]Ack (reply message to data processing result), as shown in S37.

It is next determined whether all of the change data stored in the change buffer 140 of the first system 100 have been transmitted to the second system 200, as shown in S38. If it is determined that the transmission has not been completed, steps S35˜S37 are repeatedly performed. However, if transmission of the change data of the first system 100 has been completed, the DSC 130 of the first system 100 transmits a ChangeDataEnd (change data-stored in the change buffer 140-transmission end message) to the second system 200. The second system 200, upon receiving the ChangeDataEnd, transmits a ChangeDataEndAck (reply message to the change data transmission end) to the DSC 130 of the first system 100, as shown in S39.

After transmitting all data stored in the database 110 and the change buffer 140 to the second system 200, The DSC 130 of the first system 100 transmits a SysStateChangeReq (system fail-over request message) to the DSC 230 of the second system 200. This is done to switch the second system 200 receiving the new schema into the active state in order to continuously provide the service, as shown in S40.

The DSC 230 of the second system 200, upon receiving the SysStateChangeReq, switches its state into the active state and transmits a SysStateChangeReqAck (reply message to the system fail-over request) to the first system 100, as shown in S41. The first system 100 thus switches its state into the standby state.

Accordingly, the second system 200 is operated as the active system providing the service by using the database 210 using the newly changed schema, the first system 100, which has switched into the standby state, stops functions in order to apply the newly changed schema and apply a new package to its system.

In other words, the first system 100 is converted into the standby system, and the second system 200 is converted into the active system.

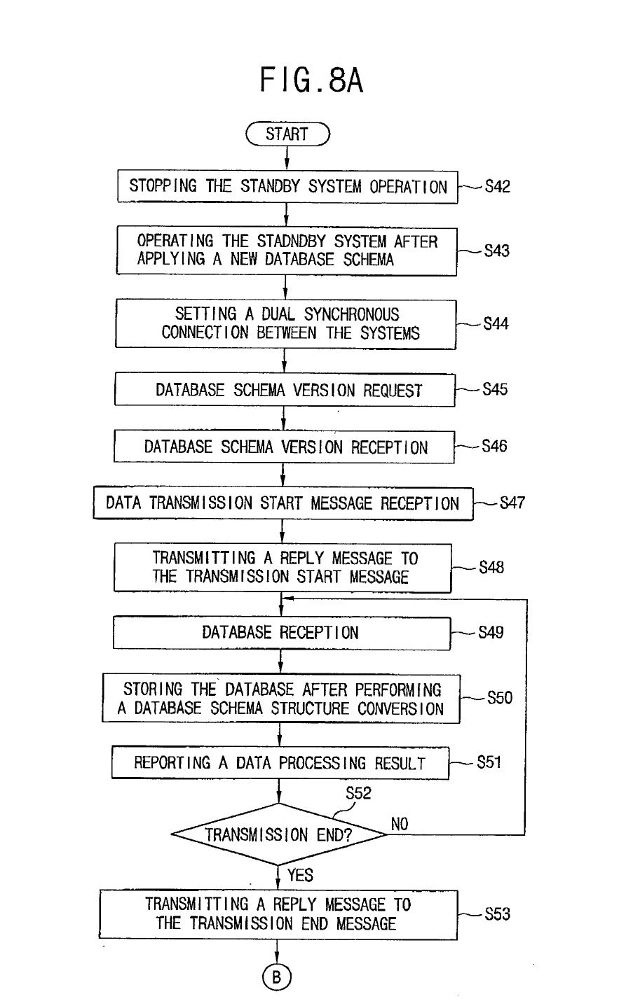

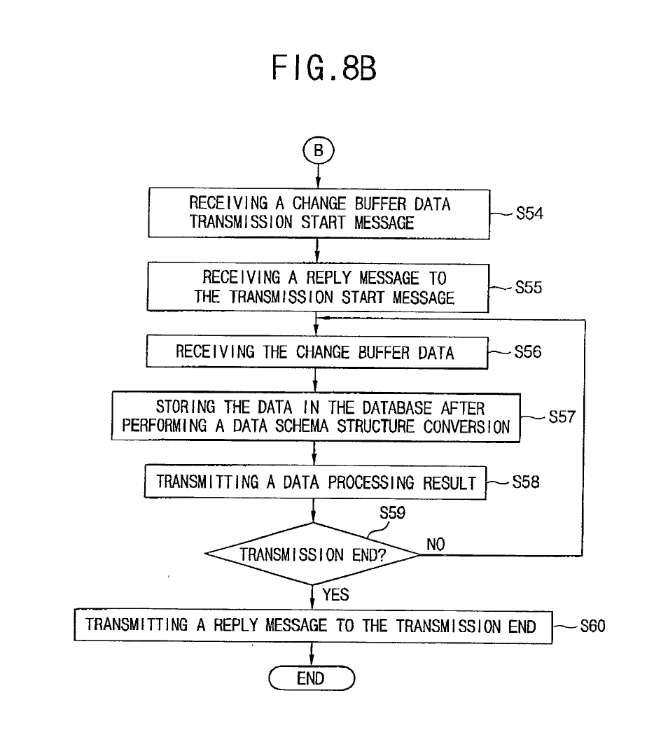

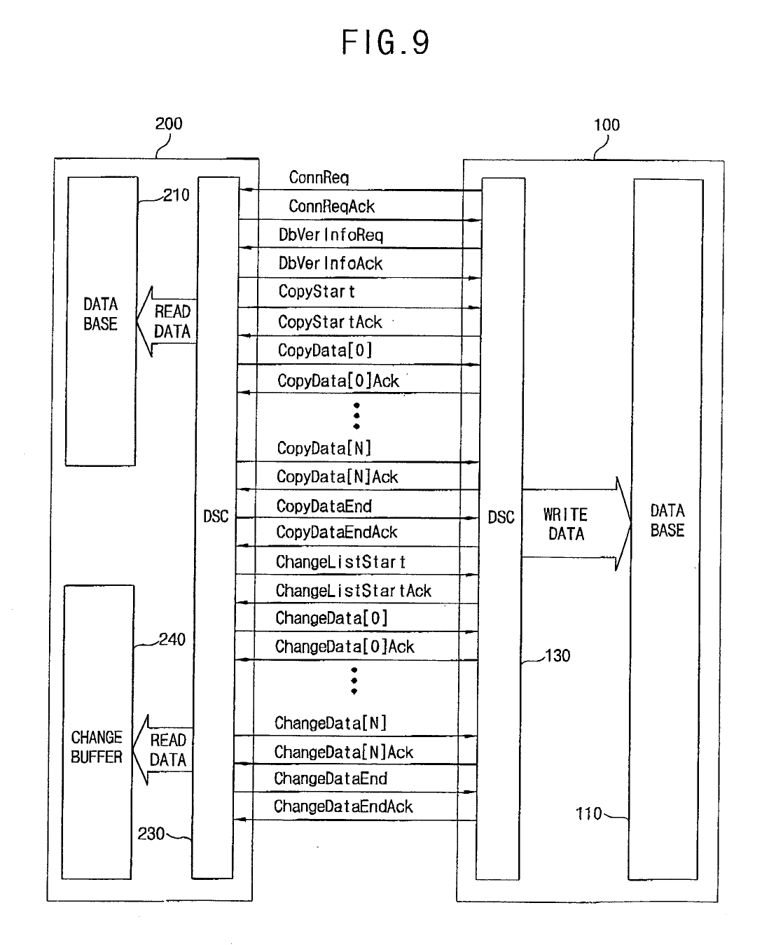

FIGS. 8a, 8b, and 9 illustrate an operation of the first system in the standby state, in accordance with a preferred embodiment. Referring to FIGS. 8a, 8b, and 9, the application of a new package to the first system 100 will be described. Initially, the first system 100 stops the system operation in order to apply a new package to itself, as shown in S42. After the newly changed database schema is applied, operation of the first system 100 is resumed, as shown S43.

The DSC 130 of the now resumed first system 100 transmits a ConnReq (connection request message) to the DSC 230 of the second system 200 to connect with the second system 200 through the dual synchronous link. In reply, the DSC 230 of the second system 200 transmits a ConnReqAck (reply message to the connection request) to the DSC 130 of the first system 100, as shown in S44.

When the dual synchronous link setting is finished, the DSC 130 transmits schema version information of the standby system 100, as well as a DbVerInfoReq (presently operating database's schema version information request message) to the DSC 230 of the second system 200, as shown in S45.

Upon receiving the DbVerInfoReq, the DSC 230 of the second system 200 gains access to version information stored in the database 210, and transmits a DbVerInfoAck (schema version information reply message) to the DSC 130 of the first system 100, as shown in S46. The DSC 230 of the second system also transmits a CopyStart (data-stored in the database 210-transmission start message) to the DSC 130 of the first system, as shown in S47.

The DSC 130 of the first system 100, upon receiving the DbVerInfoAck, recognizes that the schema version of the first system 100 is the same as that of the second system 200, and transmits a CopyStartAck (reply message to the CopyStart) to the DSC 230 of the second system 200 in order to communicate a data reception standby state to the second system 200, as shown in S48.

The DSC 230 of the second system 200 recognizes that the first system 100 is ready to receive data through the CopyStartAck, and gains access to CopyData[0], which is the first data stored in the database 210. The DSC 230 thus transmits the data to the first system 100, as shown in S49. The first system 100 stores the data received from the second system 200 in the database 110, as shown in S50, and transmits a CopyData[0]Ack (reply message to the first data processing result), as shown in S51.

In this example, because the schema version of the first system 100 is the same as that of the second system 200, the DSC 130 of the first system 100 stores the data transmitted from the second system 200 in the database 110 as it is.

The second system 200 then determines whether all data stored in the database 210 are transmitted to the first system 100, as shown in S52. When the determination is “NO,” steps S39˜S41 are repeatedly performed until data transmission is completed. However, when all data stored in the database 210 of the second system 200 have been transmitted to the first system 100, the DSC 230 of the second system 200 transmits a CopyDataEnd (data transmission end message), and the first system 100 receiving the CopyDataEnd transmits a CopyDataEndAck (reply message to the data transmission end) to the DSC 230 of the second system 200, as shown in S53.

After receiving the CopyDataEndAck, the DSC 230 of the second system 200 transmits a ChangeListStart (change data-stored in the change buffet 240-transmission start message) to the DSC 130 of the first system 100, as shown in S54. Herein, the change buffet 240 stores change data that has occurred while data stored in the database 210 of the second system 200 were being transmitted to the first system 100.

The DSC 130 of the first system 100, upon receiving the ChangeListStart, transmits a ChangeListStartAck (reply message to the change data transmission start) to the second system 200 to communicate a change data reception standby state, as shown in S55.

The DSC 230 of the second system 200 determines that the first system 100 is ready to receive change data, and gains access to a ChangeData[0], which is first change data stored in the change buffer 240. The second DSC 230 transmits the ChangeData[0] to the first system 100, as shown in S56. The DSC 130 of the first system 100 thus receives and stores the ChangeData[0] (first change data) in the database 110, as shown in S57, and tranasmits a ChangeData[0]Ack (change data processing result message), as shown in S58.

In this example, because the schema version of the first system 100 is the same as that of the second system 200, the DSC 130 of the first system 100 stores the change data received from the second system 200 in the database 110 as it is.

It is next determined whether all change data stored in the change buffer 240 of the second system 200 have been transmitted to the first system 100, as shown in S59. If the determination is “NO,” steps S46˜S48 are repeatedly performed until data transmission is completed. However, if all change data of the second system 200 have been transmitted to the first system 100, the DSC 230 of the second system 200 transmits a ChangeDataEnd (data-stored in the change buffer 240-transmission end message), and the first system 100 receives the ChangeDataEnd and transmits a ChangeDataEndAck (reply message to the data transmission end) to the DSC 230 of the second system 200, as shown in S60.

Because the schema version of the first system 100 is the same as that of the second system 200, the first system 100 receiving all data stored in the database 210 and the change buffer 240 of the second system 200 does not have to perform a fail-over.

As described above, the schema change method of the dual system in accordance with the preferred embodiment has many advantages. For example, by preferentially applying a new package according to a schema change to a standby system, receiving data from an active system, converting the data into a change schema structure, and performing a fail-over of the standby system (switching it into an active state), it is possible to continuously provide a service. Simultaneously, by applying a change schema to the active system by switching the active system into a standby state, it is possible to change schema without interrupting the service.

In addition, it is possible to prevent a service interruption due to a schema change, thus improving the reliability in service providing.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of changing a schema of a dual system where one system is active and one system is standing by, comprising:
applying a changed schema to a first system;
checking a schema version of a second system;
converting data received from the operating second system into a changed schema structure and storing it in the first system; and
performing a fail-over of the first system and the second system.

2. The method of claim 1, wherein the first system is a standby system operating in a standby mode, and wherein the second system is an active system operating in an active mode.

3. The method of claim 1, wherein applying the changed schema comprises:
stopping the operation of the first system;
applying a new schema to the first system; and
resuming an operation of the first system.

4. The method of claim 1, wherein checking the schema version comprises:
connecting the first system with the second system through a synchronous link; and
comparing the schema version of the first system with the schema version of the second system.

5. The method of claim 1, wherein storing the data comprises:
receiving data stored in a database of the second system;
converting the received data into the changed schema structure and storing it;
receiving change data stored in a change buffer; and
converting the received change data into the changed schema structure and storing it.

6. The method of claim 5, wherein the change buffer stores data that has changed during data transmission of the database.

7. The method of claim 5, wherein storing the data further comprises transmitting a processing result of the data and the change data to the second system.

8. The method of claim 1, wherein the second system, upon completing the data transmission, requests the first system to perform the system fail-over.

9. The method of claim 1, wherein the system fail-over is performed when schema versions of the first system and the second system are not the same.

10. The method of claim 1, wherein performing the system fail-over comprises switching operating states of the first system and the second system with each other.

11. The method of claim 10, wherein switching the operating states comprises:
switching the first system from a standby state into an active state; and
switching the second system from an active state into a standby state.

12. The method of claim 11, wherein switching the operating states further comprises receiving all database data from the system switched into the active state and synchronizing the data with the system switched into the standby state.

13. A method of changing a schema of a dual system, comprising:
applying a changed schema to a standby system in a standby mode;
connecting the standby system with an active system in an active mode by a dual synchronous link;
comparing schema versions of the active and standby systems;
storing data received from a database of the active system in the standby system;
storing data received from a change buffer of the active system in the standby system; and
performing a fail-over of the standby system and the active system.

14. The method of claim 13, further comprising switching an operating state of the active system and the standby system with each other when the schema versions are different from each other.

15. The method of claim 13, wherein the database of the active system and the data of the change buffer are stored in the standby system as is, when the schema versions of the active system and standby system are the same.

16. The method of claim 14, wherein converting the schema comprises:
checking table information transmitted to the standby system to determine whether a table is changed;
determining whether an old table ID is the same as a new table ID and whether a table attribute is changed, when there is a change in the table information;
checking a change type of the table attribute when the table attribute is changed; and
checking an alignment type and moving a pointer when there is a change in an attribute size.

17. The method of claim 16, wherein the pointer comprises an old pointer designating a transmitted record and a new pointer designating a new record to be stored after schema conversion.

18. The method of claim 16, wherein determining the table ID and table attribute change comprises:
storing the transmitted information in the standby system when the old table ID and the new table ID are the same and there is no change in the table attribute; and
storing the transmitted information in the standby system after changing only the table ID when the old table ID and the new table ID are different from each other and there is no change in the table attribute.

19 The method of claim 16, wherein the transmitted information comprises a record.

20. The method of claim 16, wherein checking the change type of the table attribute comprises:
copying a record in a new pointer position from an old pointer position as an old size and moving each pointer position as the old size when a table attribute change type is not designated; and
moving only the old pointer position as the old size when the table attribute is deleted.

21. The method of claim 16, wherein the alignment type comprises:
a front-end type for storing alignment from the front; and
a back-end type for storing alignment from the back.

22. The method of claim 16, wherein moving the pointer comprises:
copying a record in a new pointer position from a old pointer position as an old size; and
moving the old pointer as the old size and moving the new pointer as an AddOffset calculated by subtracting the old size from a new size when the alignment is a front-end type.

23. The method of claim 16, wherein moving the pointer comprises:
calculating an AddOffset through a difference between a new size and an old size;
calculating a LastOffset by adding the AddOffset to the new pointer;
copying a record in the LastOffset position from an old pointer as the old size; and
moving the old pointer position as the old size when the alignment is a back-end type.

24. A method of changing schema of a dual system, comprising:
applying a changed schema to a standby system;
connecting the standby system with an active system by a dual synchronous link;
comparing schema versions of the standby and active systems;
storing data received from a database of the active system in a standby system;
storing data received from a change buffer of the active system in the standby system;
performing a fail-over of the standby system and the active system;
switching an operation state of the standby system with the active system; and
receiving all databases of the system switched into the active state and synchronizing them with the system switched into the standby state.

25. The method of claim 24, wherein the change buffer stores data that has changed during the data transmission of the database.

26. A dual mobile communication system having a first system in an active state and a second system in a standby state, comprising:
first and second databases configured to store system operating data;
first and second transaction processing blocks, configured to process transactions for interlocking the first system of the dual system with the second system of the dual system;
first and second change buffers configured to store change data of the first and second databases when applying a new schema; and
first and second dual synchronization controls, configured to manage an active and standby dual state of each system and establish a synchronous link between the first and second systems to exchange data, wherein the dual system is configured to update a schema by applying a changed schema to the first system, connecting the first system with the second system by a dual synchronous link, comparing schema versions of the first and second systems, storing data received from the first database in the second system, storing data received from the first change buffer in the second system, performing a fail-over of the first and second systems, switching and operation state of the second system to an active state, and receiving all databases of the second system and synchronizing them with the first system.
